(19) United States
(12) Patent Application Publication
(10) Pub. No.: US 2015/0281641 A1
(43) Pub. Date: Oct. 1, 2015

(54) SERVER AND METHOD FOR PROCESSING VIDEO DATA OF VIDEO CONFERENCE

(71) Applicant: HON HAI PRECISION INDUSTRY CO., LTD., New Taipei (TW)

(72) Inventors: CHUNG-HAO LU, New Taipei (TW); CHIH-WEI TUNG, New Taipei (TW)

(21) Appl. No.: 14/481,930

(22) Filed: Sep. 10, 2014

(30) Foreign Application Priority Data
Mar. 31, 2014 (TW) 103111985

(51) Int. Cl. H04N 7/14; H04L 29/06

(52) U.S. Cl. CPC H04N 7/147; H04L 65/403

(57) ABSTRACT

In a method for processing video data of a number of clients of a video conference, the clients include one master client and one or more branch clients. The video data is received from the clients and the received video data of the branch clients are copied. The copied video data of the branch clients are transmitted to the master client, decoded by corresponding CODEC boxes in an array decoder box, and displayed on corresponding screens of a TV wall. The video data of the clients are transmitted to a multipoint control unit, and synthesized by the multipoint control unit to obtain synthesized video data. The synthesized video data is transmitted to each branch client, decoded by a CODEC box of the branch client, and displayed on a display device connected to the branch client.

### FIELD

Embodiments of the present disclosure generally relate to data processing technology, and particularly to a server and a method for processing video data of a video conference.

### BACKGROUND

A video conference can be initiated by a master client, and a plurality of branch clients can join the video conference. Video data of the plurality of clients is displayed on a display of each client.

### BRIEF DESCRIPTION OF THE DRAWINGS

FIG. 1 illustrates a block diagram of an embodiment of a server including a data processing system.

FIG. 2 illustrates an embodiment of a TV wall.

FIG. 3 illustrates a block diagram of an embodiment of function modules of the data processing system in FIG. 1.

FIG. 4 illustrates a flowchart of an embodiment of a method for processing video data of a video conference.

FIG. 5 illustrates an embodiment of a direction of data flow of the method in FIG. 4.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

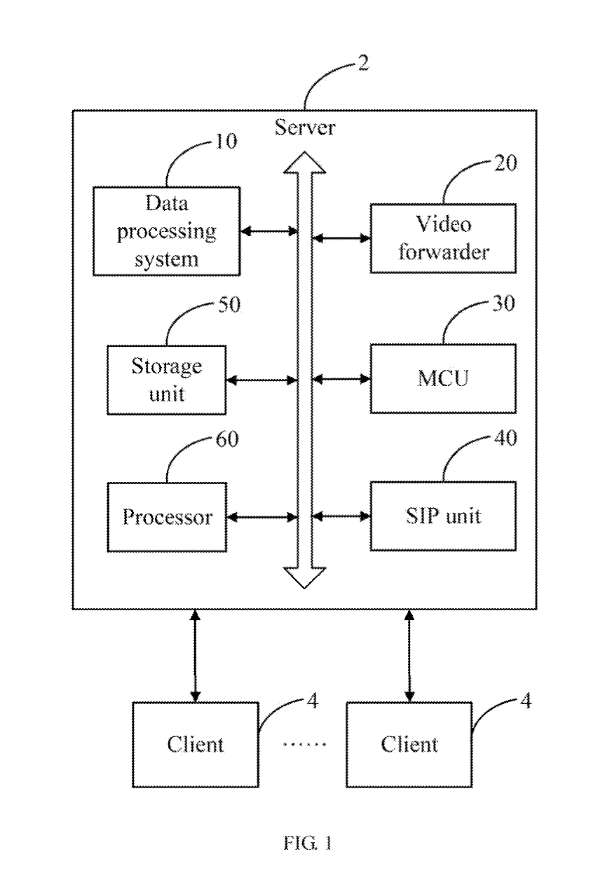

FIG. 1 illustrates a block diagram of an embodiment of a server 2. In the embodiment, the server 2 includes a data processing system 10, a video forwarder 20, a multipoint control unit (MCU) 30, a session initiation protocol (SIP) unit 40, a storage unit 50, and a processor 60. The server 2 is electronically connected to a plurality of clients 4. The data processing system 10 processes video data from the plurality of clients 4 during a video conference. The video forwarder 20 receives the video data from the clients 4 and transmits the video data to the MCU 30. The MCU 30 synthesizes the video data of the clients 4 to obtain synthesized video data. The SIP unit 40 manages a connection and communication of the clients 4 with each other.

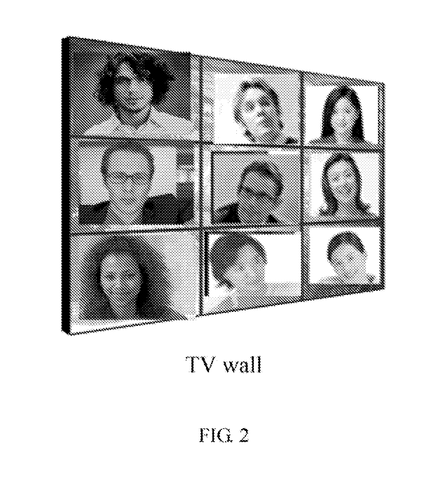

The plurality of clients 4 includes one master client 42 and one or more branch clients 44. In the embodiment, there is one master client 42 and eight branch clients 44. The master client 42 can be located in a same location as the server 2. The master client 42 includes an array decoder box (not shown). The array decoder box can include nine CODEC boxes. The master client 42 is electronically connected to a TV wall (as shown in FIG. 2). The TV wall includes nine screens.

Each of the CODEC boxes of the master client 42 corresponds to one client 4 and one screen of the TV wall. The CODEC box decodes the video data of the corresponding client 4, and transmits the decoded video data to the corresponding screen to be displayed. For example, a first CODEC box decodes the video data of a first client 4 (the master client 42), and transmits the video data to a first screen of the TV wall, and a second CODEC box decodes the video data of a second client 4 (one of the branch clients 44), and transmits the decoded video data to a second screen of the TV wall.

Each of the branch clients 44 includes a CODEC box (not shown). The CODEC box encodes the video data of the branch client 44 and decodes the synthesized video data received from the server 2. Then, the synthesized video data is transmitted to a display device (not shown) connected to the branch client 44.

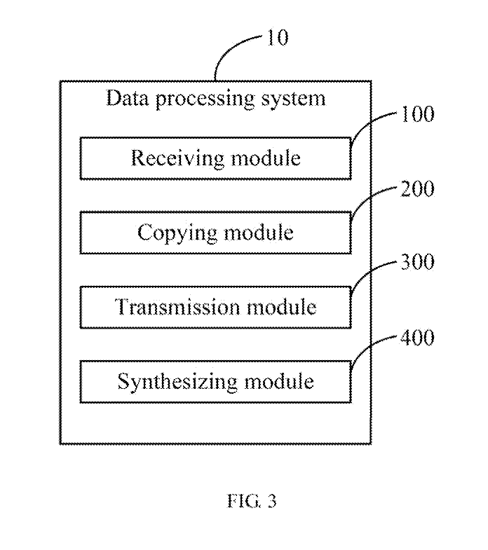

FIG. 3 illustrates a block diagram of an embodiment of function modules of the data processing system 10. The one or more function modules can include computerized code in the form of one or more programs that are stored in the storage unit 50, and executed by the processor 60 to provide functions of the data processing system 10. The storage unit 50 can be a dedicated memory, such as an EPROM or a flash memory.

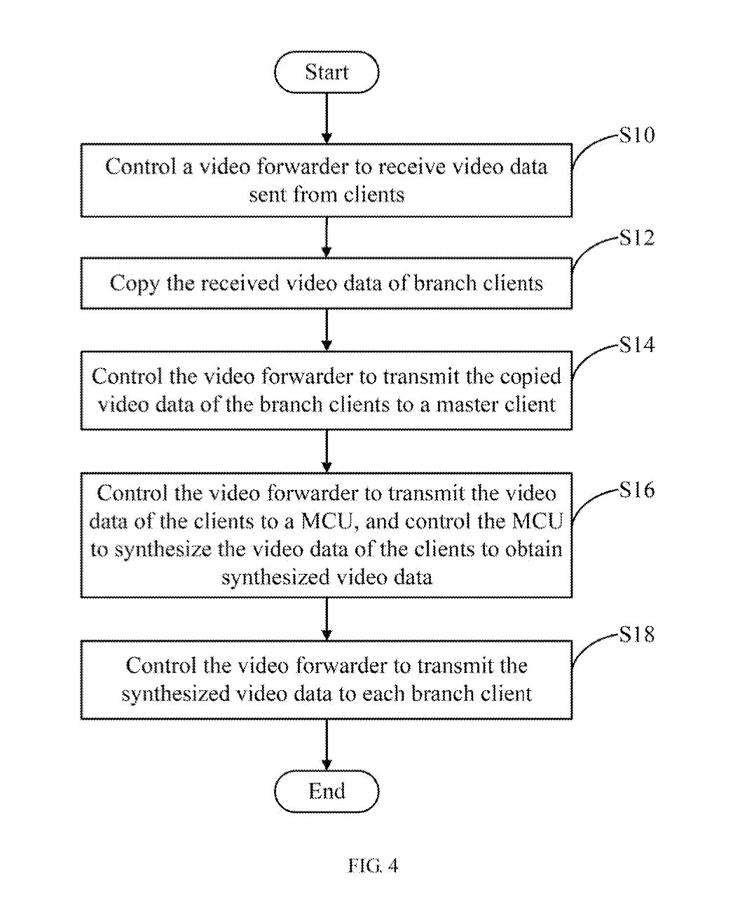

In an embodiment, the data processing system 10 includes a receiving module 100, a copying module 200, a transmission module 300, and a synthesizing module 400. Descriptions of the functions of the modules 100-400 are given with reference to FIG. 4.

FIG. 4 illustrates a flowchart of an embodiment of a method for processing video data of a video conference. Depending on the embodiment, additional steps can be added, others removed, and the ordering of the steps can be changed. The method for processing video data of the video conference includes the following steps.

In step S10, the receiving module 100 controls the video forwarder 20 to receive the video data sent from the clients 4. When a video conference is started by the master client 42, the CODEC box of each client 4 encodes the video data of the client 4, and transmits the encoded video data to the server 2. In the embodiment, the video forwarder 20 receives nine channels of encoded video data, one channel from the master client 42, and one channel from each of the eight branch clients 44.

In step S12, the copying module 200 copies the received video data of the branch clients 44.

In step S14, the transmission module 300 controls the video forwarder 20 to transmit the copied video data of the branch clients 44 to the master client 42. In the embodiment, the master client 42 stores its own video data, so that the master client 42 can display the video data of the master client 42 on the screen of the TV wall corresponding to the master client 42 directly. The copied video data of the eight branch clients 44 received by the master client 42 are decoded by the corresponding CODEC boxes in the array decoder box and displayed on the corresponding screens of the TV wall. An image resolution of each screen of the TV wall of the master client 42 can be 1920*1080, and an image resolution of the video data of each client 4 can be 1920*1080.

In step S16, the synthesizing module 400 controls the video forwarder 20 to transmit the video data of the clients 4 (the master client 42 and the branch clients 44) to the MCU 30, and controls the MCU 30 to synthesize the video data of the clients 4 to obtain synthesized video data.

In step S18, the transmission module 300 controls the video forwarder 20 to transmit the synthesized video data to each branch client 44. The synthesized video data is decoded by the CODEC box of each branch client 44 and displayed on the display device connected to each branch client 44. In the embodiment, if an image resolution of the video data of each client 4 is 1920*1080, an image resolution of the synthesized video data is 1920*1080.

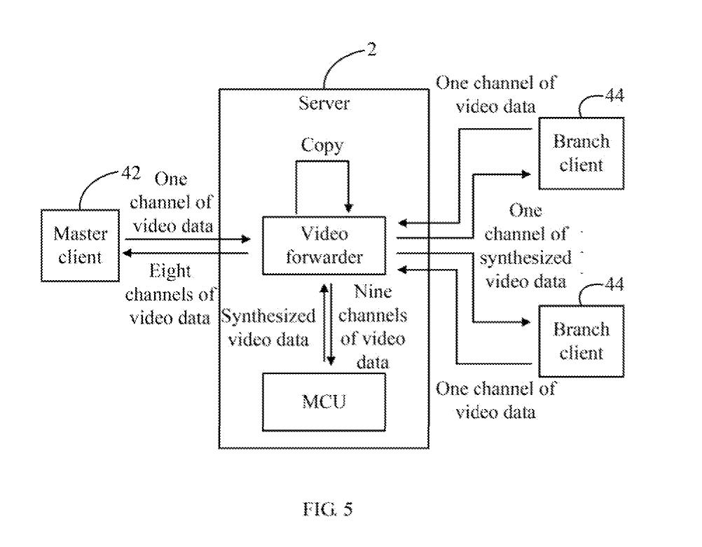

FIG. 5 illustrates an embodiment of a direction of data flow of the method. Nine channels of video data, one channel from the master client 42 and one channel from each branch client 44, is transmitted to the server 2. Only eight channels of the video data are transmitted from the server 2 to the master client 42, and only one channel of the synthesized video data is transmitted from the server 2 to each branch client 44. Therefore, the method for processing the video data of the video conference requires less network bandwidth.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A computer-implemented method, being executed by a processor of a server, the server being electronically connected to a plurality of clients, the method comprising:
(a) receiving video data of the clients, wherein the clients comprise one master client and one or more branch clients;
(b) copying the received video data of the branch clients;
(c) transmitting the copied video data of the branch clients to the master client;
(d) transmitting the video data of the clients to a multipoint control unit (MCU) of the server, and controlling the MCU to synthesize the video data of the clients to obtain synthesized video data; and
(e) transmitting the synthesized video data to each branch client.

2. The method as claimed in claim 1, wherein the synthesized video data is decoded by a CODEC box of each branch client and displayed on a display device connected to each branch client.

3. The method as claimed in claim 1, wherein the master client is electronically connected to a TV wall comprising a plurality of screens, and the master client comprises an array decoder box comprising a plurality of CODEC boxes.

4. The method as claimed in claim 3, wherein each of the plurality of CODEC boxes of the master client corresponds to one client and one screen of the TV wall.

5. The method as claimed in claim 4, wherein the copied video data of the branch clients received by the master client are decoded by the corresponding CODEC boxes in the array decoder box and displayed on the corresponding screens of the TV wall.

6. A non-transitory storage medium, storing a set of instructions, the set of instructions being executed by a processor of a server electronically connected to a plurality of clients, to perform a method comprising:
(a) receiving video data of the clients, wherein the clients comprise one master client and one or more branch clients;
(b) copying the received video data of the branch clients;
(c) transmitting the copied video data of the branch clients to the master client;
(d) transmitting the video data of the clients to a multipoint control unit (MCU) of the server, and controlling the MCU to synthesize the video data of the clients to obtain synthesized video data; and
(e) transmitting the synthesized video data to each branch client.

7. The non-transitory storage medium as claimed in claim 6, wherein the synthesized video data is decoded by a CODEC box of each branch client and displayed on a display device connected to each branch client.

8. The non-transitory storage medium as claimed in claim 6, wherein the master client is electronically connected to a TV wall comprising a plurality of screens, and the master client comprises an array decoder box comprising a plurality of CODEC boxes.

9. The non-transitory storage medium as claimed in claim 8, wherein each of the plurality of CODEC boxes of the master client corresponds to one client and one screen of the TV wall.

10. The non-transitory storage medium as claimed in claim 9, wherein the copied video data of the branch clients received by the master client are decoded by the corresponding CODEC boxes in the array decoder box and displayed on the corresponding screens of the TV wall.

11. A server, electronically connected to a plurality of clients, the server comprising:
a multipoint control unit (MCU);
at least one processor; and
a storage unit storing one or more programs, which when executed by the at least one processor, causes the at least one processor to:
receive video data of the clients, wherein the clients comprise one master client and one or more branch clients;
copy the received video data of the branch clients;
transmit the copied video data of the branch clients to the master client;
transmit the video data of the clients to the MCU, and controlling the MCU to synthesize the video data of the clients to obtain synthesized video data; and
transmit the synthesized video data to each branch client.

12. The server as claimed in claim 11, wherein the synthesized video data is decoded by a CODEC box of each branch client and displayed on a display device connected to each branch client.

13. The server as claimed in claim 11, wherein the master client is electronically connected to a TV wall comprising a plurality of screens, and the master client comprises an array decoder box comprising a plurality of CODEC boxes.

14. The server as claimed in claim 13, wherein each of the plurality of CODEC boxes of the master client corresponds to one client and one screen of the TV wall.

15. The server as claimed in claim 14, wherein the copied video data of the branch clients received by the master client are decoded by the corresponding CODEC boxes in the array decoder box and displayed on the corresponding screens of the TV wall.
